(19) United States
(12) Patent Application Publication
(10) Pub. No.: US 2025/0277916 A1
(43) Pub. Date: Sep. 4, 2025

(54) SYSTEMS AND METHODS FOR DEPLOYING SEISMIC LAND SENSORS

(71) Applicant: SAUDI ARABIAN OIL COMPANY, Dhahran (SA)

(72) Inventors: Faisal Aldughaither, Dhahran (SA); Abdulrahman Alshuail, Dhahran (SA)

(73) Assignee: SAUDI ARABIAN OIL COMPANY, Dhahran (SA)

(21) Appl. No.: 18/594,498

(22) Filed: Mar. 4, 2024

(51) Int. Cl. G01V 1/16

(52) U.S. Cl. CPC G01V 1/168; G01V 2210/1429

(57) ABSTRACT

Various measurement devices, systems including measurement devices, and methods for using measurement devices are discussed. As one of many examples, a measurement device is discussed that includes: a mesh configured to allow a ground material in contact with the measurement device pass through the mesh, a motion sensor coupled to the mesh, a drive system coupled to the mesh, and an operational sensor coupled to the mesh.

### BACKGROUND

Seismic surveys are used in the oil and gas industries to image subterranean features. The resulting images may be used in the search for oil and gas reservoirs. Such seismic surveys rely upon propagation and sensing of a large number of seismic waves using, for example, tens of thousands of seismic sensors deployed near the surface of a region being imaged. Deploying tens of thousands of sensors is labor intensive and potentially hazardous.

Hence, there exists a need in the art for advanced systems and methods for deploying seismic sensors.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Various embodiments provide measurement devices. In some such embodiments, the measurement devices include: a mesh configured to allow a ground material in contact with the measurement device pass through the mesh; a motion sensor coupled to the mesh that is configured to acquire ground motion measurements at a measurement point; a drive system coupled to the mesh and configured to vibrate the mesh; and at least one operational sensor coupled to the mesh and configured to detect operational data related to operation of the measurement device. In some cases, the measurement device further includes a controller coupled to the mesh and configured to: receive information from the motion sensor and the at least one operational sensor, and control the drive system and the motion sensor based on the information.

Some embodiments provide methods for acquiring seismic measurements. Some such methods involve a measurement device that includes: a mesh configured to allow a ground material in contact with the measurement device pass through the mesh; a motion sensor coupled to the mesh and configured to acquire ground motion measurements at a measurement point; a light sensor coupled to the mesh and configured to generate an output corresponding to sensed light; a drive system coupled to the mesh; and a controller coupled to the mesh. The controller may be configured to receive the output. The methods may include: placing the measurement device at a location, activating the drive system by the controller such that drive system causes the mesh to vibrate, and deactivating the drive system by the controller when the output indicates an absence of light.

Other such embodiments may include: deploying a measurement device at a location; triggering the measurement device to self-install; retrieving the measurement device using an indicator; and transferring the ground motion measurements via a port.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. When reference is made to a reference numeral without specification to an existing sub-label, it is intended to refer to all such multiple similar components.

FIG. 1 illustrates a data acquisition system including a number of self-installing measurement devices in accordance with some embodiments, where the self-installing measurement devices are deployed on a surface of a subterranean region to be imaged.

FIGS. 2A-2B are top views of a self-installing measurement device in accordance with various embodiments;

FIG. 2C is a side view of the self-installing measurement device of FIGS. 2A-2B.

FIG. 3 is a flow diagram showing a method for deploying a self-installing measurement device including autonomous installation in accordance with some embodiments.

FIGS. 4A-4D show side views of a self-installing measurement device autonomously working its way below a surface in accordance with various embodiments.

FIG. 5 is a flow diagram showing a method of deploying and recovering a self-installing measurement device in accordance with some embodiments.

FIG. 6 is a flow diagram showing a method for acquiring seismic measurements in accordance with various embodiments.

FIG. 7 is a flow diagram showing another method for acquiring seismic measurements in accordance with some embodiments.

### DETAILED DESCRIPTION

Various embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “cell” includes reference to one or more of such cells.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the elements shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

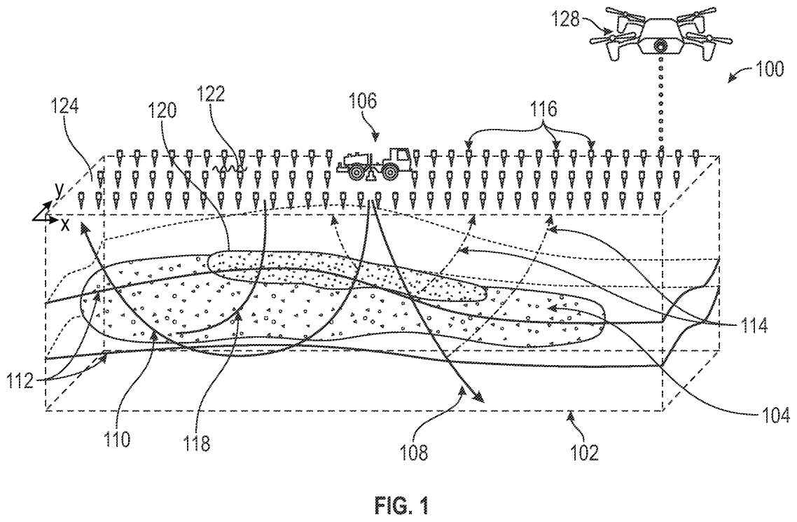

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

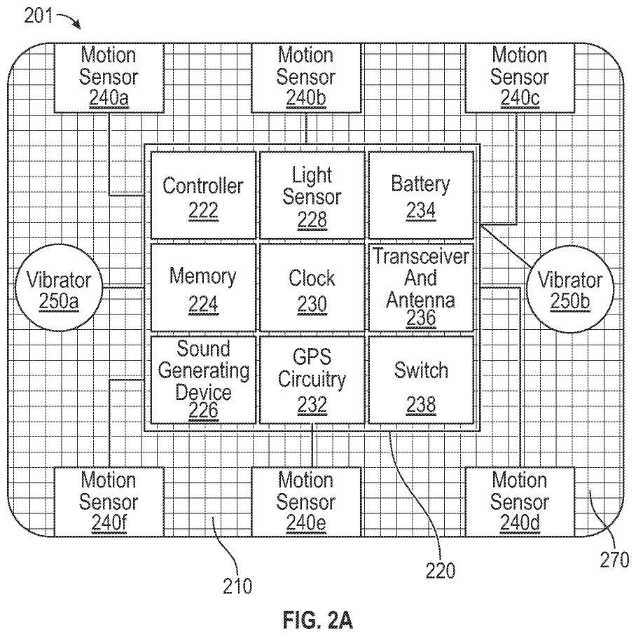

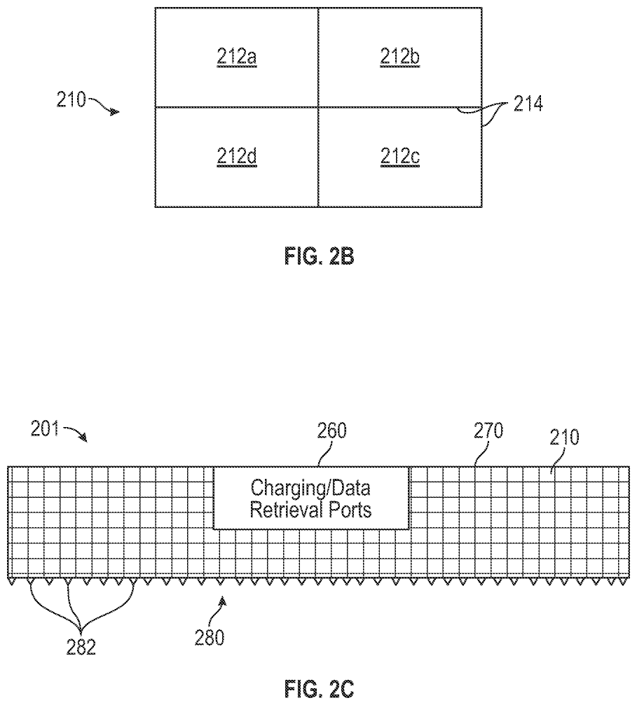

Turning to FIG. 1, a data acquisition system 100 is shown in accordance with some embodiments. Data acquisition system 100 includes a number of self-installing measurement devices 116 in accordance with various embodiments. Self-installing measurement devices 116 may be implemented similar to that detailed below in relation to FIGS. 2A-2B. Based upon the disclosure provided herein, one of ordinary skill in the art will recognize a variety of self-installing measurement devices that may be used in relation to different embodiments.

Self-installing measurement devices 116 are shown deployed over a surface 124 of a subterranean region 102 that is to be imaged. As shown, subterranean region 102 includes: geological discontinuities 112, a hydrocarbon reservoir 104, and a gas deposit 120. While geological discontinuities 112, hydrocarbon reservoir 104, and gas deposit 120 are shown, one of ordinary skill in the art will recognize a variety of subterranean features that may be imaged using self-installing measurement devices 116 in accordance with different embodiments. A wellbore 118 extends from surface 124 into subterranean region 102.

A source 106 generates radiated waves 108 that propagate through subterranean region 102. In a land environment, source 106 may be, but is not limited to, a dynamite source or one or more seismic vibrator(s) (i.e., a viborseis truck) as are known in the art. Radiated waves 108 may be sensed and recorded by one or more of self-installing measurement devices 116. In some cases, a single activation of source 106 may be recorded by tens or hundreds of thousands of self-installing measurement devices 116. Typically, in a land environment each of self-installing measurement devices 116 may include one or more ground motion sensors that record the velocity or acceleration of ground-motion caused by radiated waves 108.

Radiated waves 108 may propagate below surface 124 or may propagate along surface 124 as surface waves 122. Radiated waves 108 propagating below surface 124 may return as refracted waves 110 or may be reflected one or more times by geological discontinuities and return to surface 124 as reflected waves 114. The sensing of the aforementioned waves is referred to herein as ground motion measurements. The ground motion measurements may include acceleration.

The data sensed by many self-installing measurement devices 116 is collectively referred to as a dataset. While beyond the scope of this disclosure, this dataset may be processed to generate one or more images of the features in subterranean region 102 and/or one or more attributes of subterranean region 102. Typically, a seismic processing workflow addresses a sequence of steps including noise attenuation, acquisition regularization, multiple identification and attenuation, seismic wave propagation velocity determination, seismic imaging, and seismic attribute determination. Several of these steps, such as seismic imaging and seismic attribute attenuation, require further interpretation to identify the locations within the subsurface at which hydrocarbon accumulations may be present.

In some embodiments, a drone 128 is used to record locations of self-installing measurement devices 116 during deployment, and later as a visual indicator of the location of each of self-installing measurement devices 116 during recovery. Drone 128 includes: a processor, a memory, a location determination circuit configured to determine its location, and a wireless transceiver. The wireless transceiver of drone 128 is configured to communicate with individual self-installing measurement devices 116 as drone 128 flies near a respective measurement device. The location determination circuit is configured to determine the location of drone 128. In some cases, the location determination circuit is a global positioning system (GPS) circuit. It is noted that for the purposes of this disclosure, the terms “GPS” and “global positioning system” are used in their broadest sense to mean any aerial or satellite based position system operating on a global or regional basis. In some embodiments, a GPS circuit is capable of receiving one or more of positioning information, navigation information, and/or timing information. Based upon the disclosure provided herein, one of ordinary skill in the art will recognize a variety of systems from which location information can be derived and corresponding circuitry for generating the location information. The memory is configured to store information received from self-installing measurement devices 116 and to store instructions executable by the processor. The processor may be any processor known in the art that is capable of executing instructions to control drone 128.

In operation, an operator (not shown) carries a number of self-installing measurement devices 116 to an area of interest. Prior to being carried to the area of interest, a battery in each of self-installing measurement devices 116 has been charged and self-installing measurement devices 116 have been set to a standby mode. In the standby mode a location determination circuit included in each of self-installing measurement devices 116 determines the location of the respective measurement device, a transceiver in the each of self-installing measurement devices 116 stands ready to communicate the location information, and a clock in each of self-installing measurement devices 116 runs and indicates a current time. In some embodiments, the clock in each of self-installing measurement devices 116 is an atomic clock capable of providing an identical time as the atomic clock in each of the other self-installing measurement devices 116. This allows for accurate time stamping of data gathered by any of self-installing measurement devices 116, and for accurate correlation of data gathered by one self-installing measurement device 116 to data gathered by other self-installing measurement devices 116.

Self-installing measurement devices 116 are programmed to transition from the standby mode to an installation mode based upon a defined trigger condition. The defined trigger condition may be, but is not limited to, the particular self-installing measurement device 116 reaching a defined location as indicated by the location determination circuit in self-installing measurement device 116, a defined time as indicated by the clock in self-installing measurement device 116, the operator pressing a trigger input of self-installing measurement device 116, or reception of an install message transmitted from drone 128 passing over self-installing measurement device 116. Based upon the disclosure provided herein, one of ordinary skill in the art will recognize a variety of defined trigger conditions that may be used to transition self-installing measurement devices 116 from the standby mode to the installation mode in accordance with different embodiments.

In some embodiments, after the operator has placed the number of self-installing measurement devices 116 covering the area of interest at locations across surface 124, drone 128 is flown in a systematic pattern over the area of interest communicating with each of self-installing measurement devices 116 as it passes over the respective measurement devices. The communication with each of self-installing measurement devices 116 includes a request for the respective self-installing measurement device 116 to provide its location information followed by a response from the measurement device to drone 128 indicating a unique identification of the measurement device and its location. Drone 128 stores the location information along with the unique identification in the memory of drone 128. Subsequently, drone 128 transmits a command for the respective self-installing measurement device 116 to transition from the standby mode to the installation mode. This process of communication by drone 128 is repeated for each of self-installing measurement devices 116 resulting in a table including the location of each of self-installing measurement devices 116 stored to the memory of drone 128.

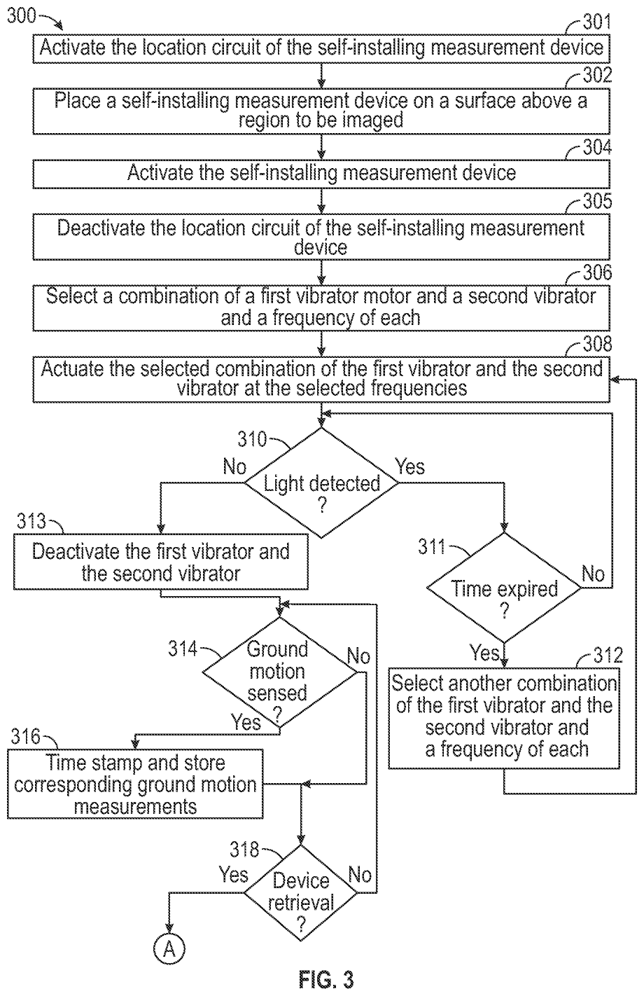

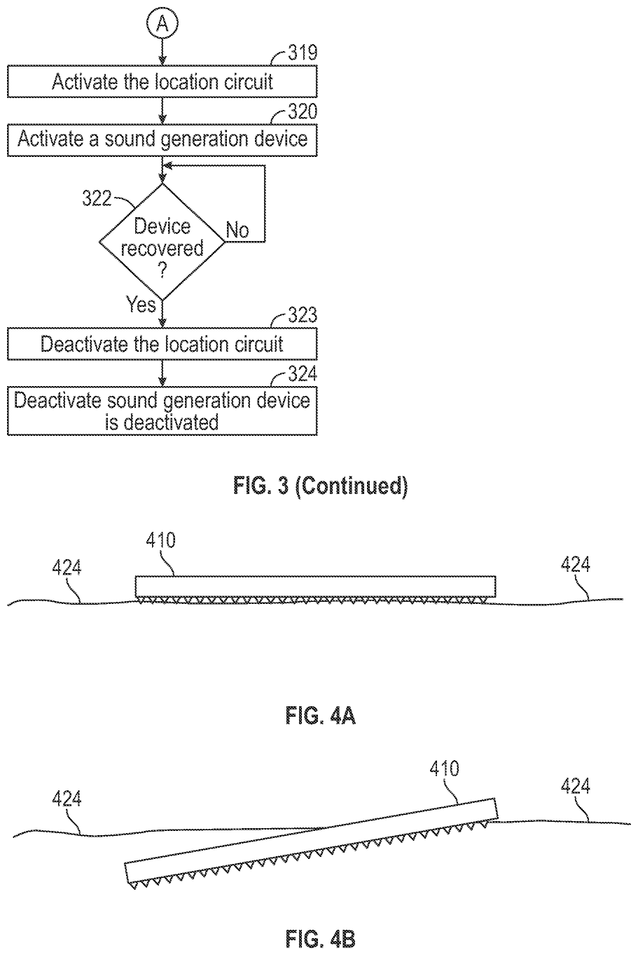

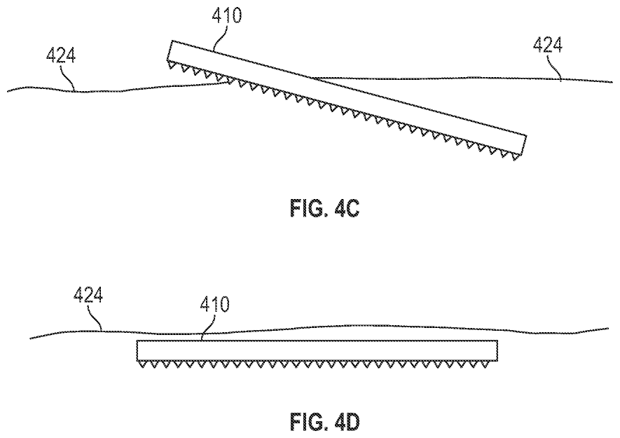

Once a respective self-installing measurement device 116 transitions to the installation mode, the measurement device begins a process of autonomously burying itself below surface 124, and subsequently transitioning to an operational mode. By burying itself below surface 124, the physical coupling of self-installing measurement device 116 and the ground is increased and exposure to surface conditions, such as wind generated noise, is decreased. This process of installation and subsequent transition to the operational mode is discussed in greater detail below in relation to FIGS. 3-4.

Once a period of operation has completed, the operator returns to recover self-installing measurement devices 116. This may include the operator moving to a location recorded for each of self-installing measurement devices 116, uncovering the self-installing measurement device 116 at that location and moving to the location of the next one of self-installing measurement devices 116. This is repeated until all of self-installing measurement devices 116 are recovered. To facilitate recovery of self-installing measurement devices 116, a number of indictors may be provided to the operator attempting the recovery. As an example, a location indicator may be provided by turning on the location circuit and of each of self-installing measurement devices 116 and transmitting the location information. Such a location indicator may be used by an operator as a guide for a location to begin digging for the measurement device. As another example, a visual indicator may be provided to the operator by drone 128 flying to the recorded location of a respective one of self-installing measurement devices 116, and hovering until the measurement device is recovered. Drone 128 may be programmed to automatically fly from the location of one self-installing measurement device 116 to the next as they are recovered. In some embodiments, the indication that a measurement device has been recovered is the operator manually turning the recovered self-installing measurement device 116 off. In some cases, two or more of the aforementioned indicators may be concurrently provided during a recovery period.

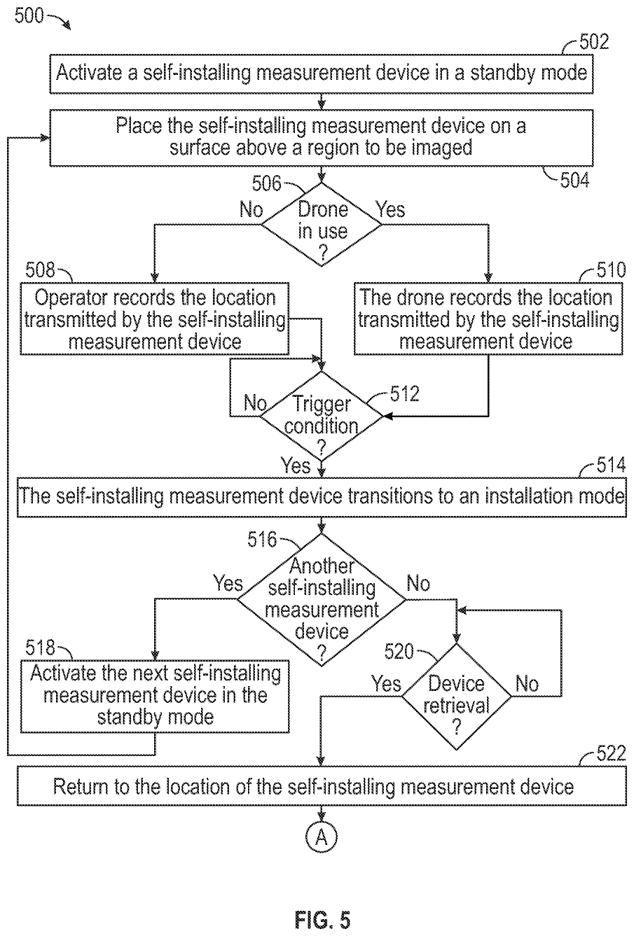

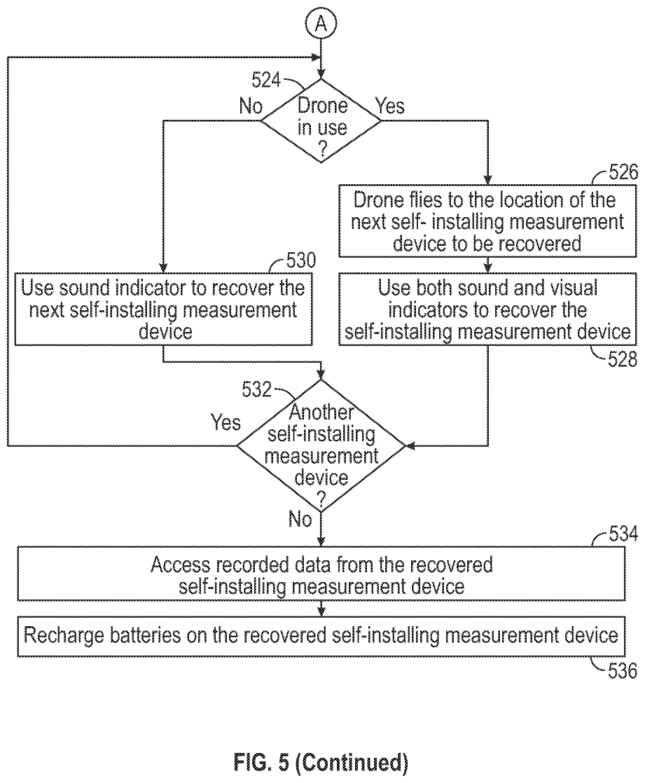

Once recovered, a data port on each of self-installing measurement devices 116 can be accessed and the data previously recorded by self-installing measurement devices 116 can be uploaded to a data processing system (not shown) where the data is used. Use of such data is beyond the scope of this disclosure. A battery of each of recovered self-installing measurement devices 116 may be recharged. After this, the recovered self-installing measurement devices 116 may be re-deployed. FIG. 5 below describes a method of deploying and recovering self-installing measurement devices 116 in accordance with some embodiments.

Turning to FIGS. 2A-2B, top views are shown of a self-installing measurement device 201 in accordance with various embodiments. As mentioned above, self-installing measurement device 201 is one example of a self-installing measurement device that may be used in relation to data acquisition system 100 of FIG. 1. As shown in FIG. 2A, self-installing measurement device 201 includes a mesh 210 that is configured to allow a ground material on which mesh 210 is deployed to pass through.

As shown in the expanded view of FIG. 2B, mesh 210 includes openings 212 (e.g., an opening 212a, an opening 212b, an opening 212c, and an opening 212d) that are each defined by structural members 214 surrounding the respective opening. In some embodiments, structural members 214 are formed of a metal core coated with a flexible plastic material. In other embodiments, structural members 214 are formed of rigid or a flexible plastic material.

Openings 212 are configured to be larger than an expected granule size of the ground material. As an example, where self-installing measurement device 201 is to be deployed in a sandy area, openings 212 in mesh 210 may be designed to be larger than the grains of sand in the area. In some embodiments, the area of openings 212 are more than four (4) times as large as a maximum expected cross-sectional area of granules of the ground material. In other embodiments, openings 212 are more than eight (8) times as large as a maximum expected cross-sectional area of granules of the ground material. Based upon the disclosure provided herein, one of ordinary skill in the art will recognize a variety of dimensions of openings 212 and/or compositions of structural members 214 that may be used in relation to different embodiments.

Returning to FIG. 2A, self-installing measurement device 201 includes a drive system configured to vibrate mesh 210. The drive system includes two vibrators 250. The drive system may include one or more vibrators 250 (e.g., a vibrator 250a and a vibrator 250b) attached to mesh 210. While self-installing measurement device 201 is shown with two vibrators 250 disposed on opposite ends of self-installing measurement device 201, one of ordinary skill in the art will appreciate different numbers of vibrators and/or locations of vibrators on mesh 210 that may be used in relation to different embodiments. In some embodiments, vibrators 250 each include a motor, a rotating eccentric mass, and a power supply unit. The motor uses power supplied by the power supply unit to move the rotating eccentric mass causing vibration. Based upon the disclosure provided herein, one of ordinary skill in the art will recognize other types of vibrators that may be used in relation to different embodiments.

The vibration of mesh 210 caused by the drive system encourages granules of the ground material upon which self-installing measurement device 201 is placed to move through openings 212 toward an upper surface 270. As more and more granules of the ground material pass through mesh 210, self-installing measurement device 201 becomes buried below the ground material. Burial of self-installing measurement device 201 increases the physical coupling of self-installing measurement device 116 and the ground is increased and exposure to surface conditions is decreased.

Self-installing measurement device 201 further includes a number of motion sensors 240 (e.g., a motion sensor 240a, a motion sensor 240b, a motion sensor 240c, a motion sensor 240d, a motion sensor 240e, and a motion sensor 240f) distributed around the edges. Motion sensors 240 may be configured to acquire ground motion measurements at a measurement point. The fidelity of motion sensors 240 may increase when they are buried beneath the surface as it increases the physical coupling of motion sensors 240 and the ground, and a buried sensor is not exposed to, for example, air flow above the surface.

Motion sensors 240 may be any sensors known in the art that can be attached to mesh 210 and used for acquiring ground motion measurements at a location where self-installing measurement device 201 is deployed. Such motion sensors 240 are of a size that limits interference with self-installing measurement device 201 burying itself. In some embodiments, motion sensors 240 are micro-electro-mechanical (MEMS) sensors. In other embodiments, motion sensors are geophones. Based upon the disclosure provided herein, one of ordinary skill in the art will recognize a variety of different types of motion sensors that may be used in relation to different embodiments.

As more fully described below, as self-installing measurement device 201 autonomously buries itself below the surface, it is possible that one side of the measurement device may be fully buried, while another side remains unburied. As motion sensors 240 are distributed around the edges, even when a partially buried condition occurs, one or more of motion sensors 240 will be buried, and thus provide the fidelity expected from a buried sensor. Further, even where a full buried condition (i.e., all of motion sensors 240 are buried disposed beneath the surface) exists, having sensed information from multiple motion sensors allows for rotating the sensed information to a desired axis plane.

Self-installing measurement device 201 further includes an electronics module 220 including various electronic circuitry is included. In some embodiments, electronics module 220 is monolithic. In other embodiments, electronics module 220 includes a group of sub-modules interconnected by electrical conductors. Such a sub-module approach allows for spacing between individual sub-modules that allow granules of the ground to pass between them as self-installing measurement device 201 autonomously installs. This makes the overall surface area of electronics module less of an impediment to the self-installation process.

Electronics module 220 includes: a controller 222, a memory 224, a sound generating device 226, a light sensor 228, a clock 230, GPS circuitry 232, a battery 234, a transceiver and antenna 236, and a switch 238. Controller 222 is configured to direct the operations of self-installing measurement device 201. Such direction includes, but is not limited to, receiving ground motion measurements from motion sensors 240, time stamping ground motion measurements and other status information using a time output from clock 230, storing the time stamped ground motion measurements and other status information to memory 224, activating and deactivating the drive system based upon one information received from, for example, light sensor 228, activating and deactivating GPS circuitry 232 based upon one or more defined conditions, sensing and reporting a power level of battery 234, receiving an output from light sensor 228, communicating messages and generating messages via a transceiver and antenna 236, and/or changing an operation of self-installing measurement device 201 based upon, for example, an output from trigger 230. Again, the term “GPS” is used in the previously described broad sense.

Battery 234 is configured to provide power to vibrators 250, motion sensors 240, and the various components of electronics module 220. Battery 234 can be recharged via an external access port 260 discussed below in relation to FIG. 2C. In some embodiments, battery 234 is a lithium-ion battery. Based upon the disclosure provided herein, one of ordinary skill in the art will recognize other types of batteries that may be used in relation to different embodiments.

Clock 230 is configured to provide a continuous time output. This continuous time output may be used to, for example, time stamp ground motion measurements from motion sensors 240, and/or to trigger activation of vibrators 250. In some embodiments, clock 230 is an atomic clock capable of providing an identical time in one self-installing measurement device 201 as that available in other instances of self-installing measurement devices 201 deployed together in a data acquisition system. This allows for accurate correlation of data gathered by all instances self-installing measurement devices 201.

Memory 224 is communicably coupled to controller 222. Memory 224 is configured to: store ground motion measurements from motion sensors 240 and other operational information about self-installing measurement device 201, and/or store instructions executable by controller 222 to control the operation of self-installing measurement device 201. The stored information may be time stamped using a time accessed from clock 230.

Light sensor 226 is configured to sense light impinging on self-installing measurement device 201. The output of light sensor 226 may, in some embodiments, be a binary output indicating either an absence of light or an occurrence of light. An absence of light is indicated when an amount of light falls below a threshold of light sensor 226, and above the threshold an occurrence of light is indicated. In some embodiments, light sensor 226 includes a photodiode and the threshold is that of the photodiode. In some such embodiments, the photodiode is tuned to sense visible light and filter out, for example, infrared light or heat emanating from the ground in which self-installing measurement device 201 is buried. In operation, the output of light sensor 226 is used as a proxy for whether self-installing measurement device 201 is buried. Where the output of light sensor 226 indicates an absence of light, self-installing measurement device 201 is considered buried. In contrast, where the output indicates the occurrence of light, self-installing measurement device 201 is not considered buried. Based upon the disclosure provided herein, one of ordinary skill in the art will recognize a variety of light sensors that may be use in relation to different embodiments.

Switch 238 may be, for example, a pressure activated switch that when pushed by an operator changes the operational status of self-installing measurement device 201. For example, an operator may press switch 238 to activate the drive system or to deactivate the drive system.

GPS circuitry 232 includes a GPS sensor configured to sense information from a number of satellites or other areal devices, and a location circuit configured to determine a spatial position (i.e., a location) of self-installing measurement device 201 based on the information sensed by the GPS sensor. Based upon the disclosure provided herein, one of ordinary skill in the art will recognize alternative location technologies that may be used in relation to different embodiments.

Transceiver and antenna 236 are configured to transmit communications via a wireless communication link. Such communications may include, but are not limited to, commands from drone 128 or another remote device (e.g., a remote control station) modifying the operation of self-installing measurement device 201, location information from GPS circuitry 232 to either drone 128 or another wireless device, device status information from controller 222 to either drone 128 or another wireless device, and/or seismic data sensed and/or gathered by self-installing measurement device 201 from controller 222 to either drone 128 or another wireless device. Based upon the disclosure provided herein, one of ordinary skill in the art will recognize a variety of communications that may be facilitated by transceiver and antenna 236 in accordance with different embodiments.

Sound generating device 226 may be any device known in the art for generating a human audible or machine detectable sound that can be used as an audio indicator facilitating the recovery of self-installing measurement device 201. Alternatively, or in addition, controller 222 may cause sound generating device 226 to generate a sound when a malfunction of self-installing measurement device 201 is detected. In some cases, sound generating device 226 may generate different sounds depending on the condition being indicated by the particular sound.

Turning to FIG. 2C, an anchorage system 280 extends from a bottom surface of self-installing measurement device 201. Anchorage system 280 includes a number of bumps 282 configured to enhance a coupling with the ground, and thereby enhance the fidelity of ground motion sensed by motion sensors 240. Self-installing measurement device 201 further includes an external access port 260 through which: battery 234 can be connected to a power source via a physical cable (not shown) for recharging, data can be transferred from memory 224 via a physical cable to an external device (not shown), and programming commands can be transferred to memory 224 via a physical cable.

Turning to FIG. 3, a flow diagram 300 shows a method in accordance with some embodiments for deploying and using a self-installing measurement device. Following flow diagram 300, a location circuit of the self-installing measurement device is activated prior to deployment (block 301). In some embodiments, the location circuit is a GPS based location circuit that allows the self-installing measurement device to determine and report its location. The self-installing measurement device is placed on a surface above a region to be imaged (block 302). This placement may be done, for example, by a human operator. In some embodiments, the self-installing measurement device may be self-installing measurement device 201 described above in relation to FIGS. 2A-2C. In such embodiments, the self-installing measurement device is placed such that anchorage system 280 is in contact with the ground. Turning to FIG. 4A, a side view of a self-installing measurement device 410 placed on a surface 424 is shown.

In some embodiments, as part of placing the self-installing measurement device (block 302), an operator placing the measurement device may cause a hand carried recorder (not shown) to store the identification of the self-installing measurement device along with a location of the self-installing measurement device generated either by the hand carried recorder or transmitted from a location circuit of the self-installing measurement device. In other embodiments, a drone flying over the operator may receive and record the identification and location information received via wireless communication from the self-installing measurement device.

The self-installing measurement device is activated (block 304). This may include transitioning the self-installing measurement device from a standby mode to an installation mode. In the installation mode one or more vibrators of the self-installing measurement device are enabled to begin vibrating. In some embodiments, activating the self-installing measurement device is done by an operator pressing a switch on the self-installing measurement device. In such embodiments, the self-installing measurement device may be activated prior to its placement on the ground. In other embodiments, activating the self-installing measurement device is done automatically based upon a location circuit in the self-installing measurement device indicating that the measurement device is at a programmed location. In such embodiments, the self-installing measurement device may be activated either prior to its placement on the ground or after its placement on the ground. In yet other embodiments, activating the self-installing measurement device is done automatically after an activation command has been received via a transceiver and antenna in the self-installing measurement device. In such embodiments, the self-installing measurement device may be activated either prior to its placement on the ground or after its placement on the ground. In some cases, this activation command is received from a drone flying near the self-installing measurement device. In other cases, this activation command is received from a fixed location remote control station. In yet further embodiments, activating the self-installing measurement device is done automatically when a clock in the self-installing measurement device indicates a programmed time. In such embodiments, the self-installing measurement device may be activated either prior to its placement on the ground or after its placement on the ground.

In some embodiments, the location circuit of the self-installing measurement device is deactivated to save battery power (block 305). A combination of a first vibrator and a second vibrator included in the self-installing measurement device is selected along with a frequency at which each will vibrate (block 306). In some embodiments this may include selecting both vibrators to vibrate at the same frequency. In other embodiments, this may include selecting only one of the two vibrators vibrating at a frequency. In yet other embodiments, this may include selecting the first vibrator to vibrate at a first frequency and the second vibrator to vibrate at a second frequency. In some embodiments, the combination of vibrators and frequencies is selected by a controller in the self-installing measurement device and according to a preprogrammed schedule included in the memory of the self-installing measurement device. While the embodiment of FIG. 3 is described as using two vibrators, other embodiments may include more or fewer vibrators.

The selected combination of vibrators is actuated to operate at the selected frequencies (block 308). Actuating the vibrators causes the selected vibrator(s) to turn on and operate at the selected frequency or frequencies. The vibrators cause a mesh of the self-installing measurement device to vibrate, thus encouraging granules of the ground material to move through openings in the mesh toward an upper surface of the self-installing measurement device. As this vibration is ongoing, an output from a light sensor in the self-installing measurement device is monitored to determine whether light is detected (block 310). The output of the light sensor is used as a proxy for whether the self-installing measurement device is buried. Where the output of the light sensor indicates an absence of light, the self-installing measurement device is considered buried. In contrast, where the output indicates the occurrence of light, the self-installing measurement device is not considered buried. In various embodiments, a clock is included that may be used to compensate for night time, and in such a situation the level of light must be even lower during night time hours for the device to consider itself buried.

Where light is still detected (block 310), it is determined whether a programmed time period has elapsed since the combination of vibrators was actuated (block 311). Where the programmed time period has not yet passed (block 311), the process of block 310 continues. Alternatively, where the programmed time period has passed (block 311), another combination of the first vibrator and the second vibrator is selected along with a frequency at which each will vibrate (block 312). Again, this may include selecting one or more vibrators and one or more frequencies. Further, such selection may be done by a controller in the self-installing measurement device and according to a preprogrammed schedule included in the memory of the self-installing measurement device. After selecting the next combination of vibrators and corresponding frequencies (block 312), the process beginning at block 308 is repeated.

Alternatively, where light is no longer detected (block 310), the first vibrator and the second vibrator are deactivated (block 313). Light ceases to be detected when the light sensor in the self-installing measurement device is sufficiently below the surface. Where a single light sensor is deployed near the center of the self-installing measurement device, such a failure to detect light may indicate a partial burial as the examples shown in FIGS. 4B-4C. In such examples, the vibration of self-installing measurement device 410 has caused one side of the measurement device to become buried, while the other side remains above surface 424. In such a condition, motion sensors on the buried side of self-installing measurement device 410 will be coupled with the ground (i.e., couple ground motion to the motion sensor) and operate effectively. In contrast, motion sensors on the unburied side of self-installing measurement device 410 may not provide the desired fidelity. In such a cases, ground motion measurements from the unburied motion sensors may be filtered out during subsequent processing of data gathered from a number of measurement devices. Alternatively, as shown in FIG. 4D, self-installing measurement device 410 may become fully buried during the vibration process resulting in good coupling between the ground and all motion sensors in the self-installing measurement device.

With the self-installing measurement device either fully or partially buried as indicated by the lack of light being detected by the light sensor (block 310), the measurement device is transitioned to a measurement mode where it is determined whether ground motion is sensed (block 314). As ground motion is sensed (block 314), the corresponding ground motion measurements from the motion sensors of the self-installing measurement device are time stamped using a real time output from a clock of the self-installing measurement device, and the time stamped ground motion measurements is stored to a memory in the self-installing measurement device (block 316).

The process of sensing, time stamping, and storing ground motion measurements (blocks 314-316) continues until a device retrieval trigger occurs (block 318). A device retrieval trigger may be any signal indicating that the self-installing measurement device is to be retrieved. In some embodiments, the retrieval trigger is a programmed end time. Based upon the disclosure provided herein, one of ordinary skill in the art will recognize a variety of retrieval triggers that may be used in relation to different embodiments.

Once the retrieval trigger occurs (block 318), the location circuit in the self-installing measurement device is activated (block 319) and a sound generation device in the self-installing measurement device is activated (block 320). Upon activation, the sound generation device emits a sound with sufficient power to be sensed above the surface, and the location circuit determines a location of the self-installing measurement device and wirelessly transmits the location information in a way that can de sensed above the surface. The sound may be human audible and/or machine audible and provides an audio indicator facilitating the recovery of the self-installing measurement device. The transmitted location information may be used by an operator to guide them to the location received by sensing the transmitted location information.

It is determined whether the self-installing measurement device has been recovered by an operator (block 322). Such recovery includes extracting the self-installing measurement device from the ground. In some embodiments, recovery is indicated by the operator pressing a switch on the self-installing measurement device. Once it is determined that the self-installing measurement device has been recovered (block 322), the location circuit is deactivated (block 323) and the sound generation device is deactivated (block 324).

Turning to FIG. 5, a flow diagram 500 shows a method of deploying and recovering a self-installing measurement device in accordance with some embodiments. In some embodiments, the self-installing measurement device may be self-installing measurement device 201 described above in relation to FIGS. 2A-2C. Following flow diagram 500, a self-installing measurement device is activated in a standby mode (block 502). In the standby mode various functions of the self-installing measurement device are activated, but others are not activated. For example, in some embodiments, location functionality of the self-installing measurement device may be activated in the standby mode, while vibration functionality is not activated.

The self-installing measurement device is placed on a surface above a region to be imaged (block 504). This may include placing the self-installing measurement device such that an anchorage system of the measurement device is in contact with the ground. Where a drone is in use (block 506), the drone records the location information and identification information transmitted by the self-installing measurement device in a memory of the drone (block 510). Alternatively, where a drone is not in use (block 506), an operator placing the self-installing measurement device records the location information and identification information transmitted by the measurement device (block 508). This may be done automatically using a hand carried recorder (not shown) to store the identification of the self-installing measurement device along with a location of the self-installing measurement device. The location may be generated either by the hand carried recorder or transmitted from the self-installing measurement device.

It is determined whether a trigger condition has occurred (block 512). In some embodiments, the trigger condition is an operator pressing a switch on the self-installing measurement device. In such embodiments, the triggering condition may occur prior to placing the device on the ground. As one example, in other embodiments, the trigger condition occurs automatically. In some embodiments, the trigger condition occurs when the location circuit in the self-installing measurement device indicates that the measurement device is at a programmed location. In such embodiments, the triggering condition may occur prior to placing the device on the ground, or after placing the device on the ground. As another example, in some embodiments, the trigger condition occurs when an activation command is received via a transceiver and antenna in the self-installing measurement device. This activation command may be received from a drone flying near the self-installing measurement device or from a fixed location remote control station. In such embodiments, the triggering condition may occur prior to placing the device on the ground, or after placing the device on the ground. As yet another example, in some embodiments, the trigger condition occurs when a clock in the self-installing measurement device indicates a programmed time. In such embodiments, the triggering condition may occur prior to placing the device on the ground, or after placing the device on the ground.

Once the trigger condition occurs (block 512), the self-installing measurement device transitions to an installation mode (block 514). In the installation mode a drive system begins vibrating the mesh. Such vibration encourages granules of the ground material upon which the self-installing measurement device rests to move through holes in the mesh of the measurement device toward an upper surface of the measurement device. As more and more granules of the ground material pass through the mesh, the self-installing measurement device becomes at least partially buried below the ground material. The drive system may include one or more vibrators.

Where another self-installing measurement device remains to be placed (block 516), the next self-installing measurement device is activated in the standby mode (block 518) and the processes of blocks 504-516 are repeated for the next self-installing measurement device. Alternatively, where no additional self-installing measurement devices remain to be placed (block 516), it is determined whether it is time to retrieve the previously deployed self-installing measurement devices (block 520).

When it is time to retrieve the previously deployed self-installing measurement devices (block 520), the operator returns to the location where self-installing measurement devices were deployed (block 522). Where a drone is used (block 524), the drone automatically hovers over a location of one of the self-installing measurement devices providing a visual indicator that the operator can use to find the measurement device (block 526). In addition, as part of the retrieval process, a sound generating device in the self-installing measurement device is automatically activated causing a sound to be emitted from the measurement device providing an audio indicator that the operator can use to find the measurement device. The operator uses one or both of the visual indicator and the audio indicator to identify a location to dig and recover the self-installing measurement device (block 528). Alternatively, where a drone is not used (block 526), the operator may only use the audio indicator to identify a location to dig and recover the self-installing measurement device (block 530). As mentioned above in relation to FIG. 3, the location circuit in each of the self-installing measurement devices may be activated to transmit location information that may be used by an operator to locate previously deployed self-installing measurement device.

It is determined whether more self-installing measurement devices remain to be recovered (block 532). Where another measurement device remains to be recovered (block 532), the processes of blocks 524-532 are repeated for the next measurement device. Alternatively, where no self-installing measurement devices remain to be recovered (block 532), data recorded on each of the recovered self-installing measurement devices is accessed and transferred to an external device (block 534) and the batteries on each of the recovered self-installing measurement devices are recharged (block 536).

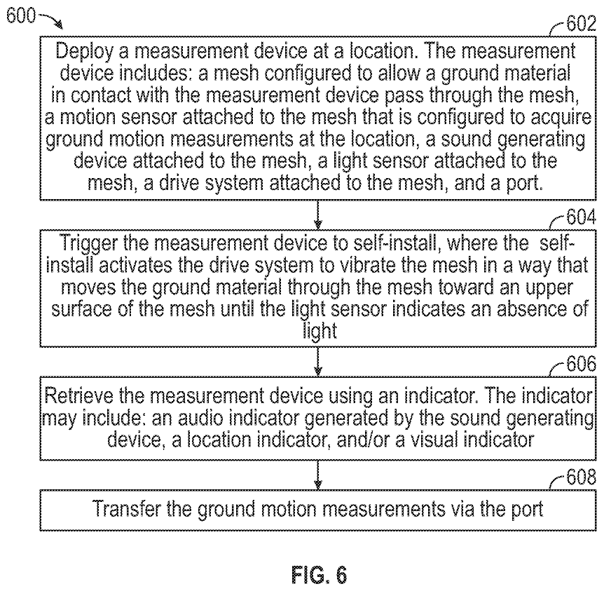

Turning to FIG. 6, a flow diagram 600 shows a method for acquiring seismic measurements in accordance with various embodiments. Following flow diagram 600, a measurement device is deployed at a location (block 602), the measurement device includes: deploying a measurement device at a location, the measurement device including: a mesh configured to allow a ground material in contact with the measurement device pass through the mesh, a motion sensor attached to the mesh and configured to acquire ground motion measurements at the location, a sound generating device attached to the mesh, a light sensor attached to the mesh, a drive system attached to the mesh, and a port. The measurement device is triggered to self-install (block 604). The self-install activates the drive system to vibrate the mesh in a way that moves the ground material through the mesh toward an upper surface of the mesh until the light sensor indicates an absence of light. The measurement device is retrieved using an indicator (block 606). The indicator includes: an audio indicator generated by the sound generating device, a location indicator, and/or a visual indicator. The ground motion measurements are transferred via the port (block 608).

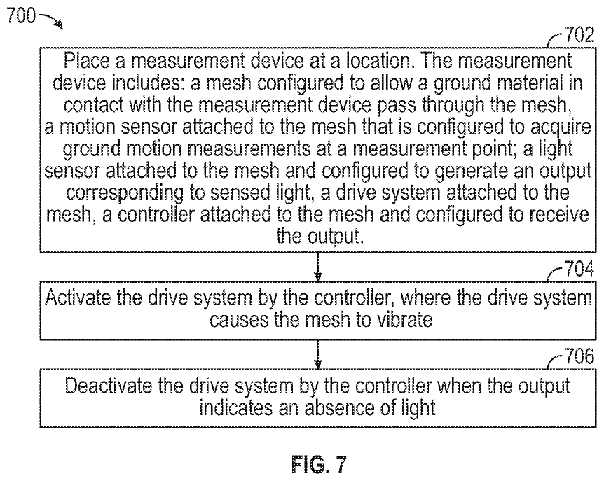

Turning to FIG. 7, a flow diagram 700 shows another method for acquiring seismic measurements in accordance with some embodiments. Following flow diagram 700, a measurement device is placed at a location (block 702). The measurement device includes: a mesh configured to allow a ground material in contact with the measurement device pass through the mesh, a motion sensor attached to the mesh and configured to acquire ground motion measurements at a measurement point, a light sensor attached to the mesh and configured to generate an output corresponding to sensed light, a drive system attached to the mesh, and a controller attached to the mesh, the controller configured to receive the output. The drive system is activated by the controller (block 702). The drive system causes the mesh to vibrate. The drive system is deactivated by the controller when the output indicates an absence of light (block 704).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A measurement device, comprising:
a mesh configured to allow a ground material in contact with the measurement device pass through the mesh;
a motion sensor coupled to the mesh, the motion sensor configured to acquire ground motion measurements at a measurement point;
a drive system coupled to the mesh, the drive system configured to vibrate the mesh;
at least one operational sensor coupled to the mesh, the at least one operational sensor configured to detect operational data related to operation of the measurement device; and
a controller coupled to the mesh, the controller configured to:
receive information from the motion sensor and the at least one operational sensor, and
control the drive system and the motion sensor based on the information.

2. The measurement device of claim 1, wherein the ground motion measurements comprise acceleration.

3. The measurement device of claim 1, the measurement device further comprising:
a sound generating device.

4. The measurement device of claim 1, wherein the at least one operational sensor comprises a light sensor configured to detect light.

5. The measurement device of claim 1, wherein the drive system comprises at least one rotating eccentric mass.

6. The measurement device of claim 5, wherein the drive system further comprises a power supply unit.

7. The measurement device of claim 1, wherein the controller is further configured to control activation of the drive system based on the information.

8. The measurement device of claim 1, wherein the operational sensors comprise a global positioning system (GPS) sensor configured to receive information used to determine a spatial position of the measurement device.

9. The measurement device of claim 1, the measurement device further comprising:
a memory configured to store at least the ground motion measurements.

10. The measurement device of claim 1, wherein the motion sensor comprises a micro-electro-mechanical sensor.

11. The measurement device of claim 1, the measurement device further comprising:
a switch switchable by a human operator, wherein the switch to configured to activate and deactivate the driving system.

12. The measurement device of claim 1, wherein the controller is further configured to receive a command via a wireless communication link, and to modify an operation of the measurement device based on the command.

13. The measurement device of claim 1, the measurement device further comprising:
an anchorage system configured to couple ground motion to the motion sensor.

14. A method for acquiring seismic measurements, the method comprising:
placing a measurement device at a location, the measurement device including:
a mesh configured to allow a ground material in contact with the measurement device pass through the mesh;
a motion sensor coupled to the mesh, the motion sensor configured to acquire ground motion measurements at a measurement point;
a light sensor coupled to the mesh, the light sensor configured to generate an output corresponding to sensed light;
a drive system coupled to the mesh; and
a controller coupled to the mesh, the controller configured to receive the output;
activating the drive system by the controller, wherein the drive system causes the mesh to vibrate; and
deactivating the drive system by the controller when the output indicates an absence of light.

15. The method of claim 14, wherein activating the drive system is based upon a trigger event selected from a group consisting of: an output from a switch on the measurement device, a location of the measurement device, a time, and a command received via a wireless communication link.

16. The method of claim 14, the method further comprising:
retrieving the measurement device, wherein retrieving the measurement device is facilitated by at least one indicator selected from a group consisting of: an audio indicator, a location indicator, and a visual indicator.

17. The method of claim 16, wherein the audio indicator comprises a sound generated by a sound generating device coupled to the mesh and controlled by the controller.

18. The method of claim 16, wherein the visual indicator comprises a drone hovering over the measurement device.

19. The method of claim 15, the method further comprising:
receiving, by the controller, the ground motion measurements;
storing, by the controller, the ground motion measurements to a memory associated with the measurement device; and
transferring, by the controller, the ground motion measurements via a port on the measurement device.

20. A method for acquiring seismic measurements, the method comprising:
deploying a measurement device at a location, the measurement device including:
a mesh configured to allow a ground material in contact with the measurement device pass through the mesh;
a motion sensor coupled to the mesh, the motion sensor configured to acquire ground motion measurements at the location;
a sound generating device coupled to the mesh;
a light sensor coupled to the mesh;
a drive system coupled to the mesh; and
a port;
triggering the measurement device to self-install, wherein the self-install activates the drive system to vibrate the mesh in a way that moves the ground material through the mesh toward an upper surface of the mesh until the light sensor indicates an absence of light;
retrieving the measurement device using an indicator selected from a group consisting of: an audio indicator generated by the sound generating device, a location indicator, and a visual indicator; and
transferring the ground motion measurements via the port.
